(19) United States
(12) Patent Application Publication
(10) Pub. No.: US 2019/0040179 A1
(43) Pub. Date: Feb. 7, 2019

(54) COMPOSITION POLYISOCYANATE BIURET

(71) Applicant: VENCOREX FRANCE, Saint-Priest (FR)

(72) Inventors: Jean-Marie BERNARD, Saint-Laurent d'Agny (FR); Philippe OLIER, Lyon (FR)

(21) Appl. No.: 15/764,660

(22) PCT Filed: Sep. 30, 2016
(86) PCT No.: PCT/EP2016/073426

§ 371 Date: Mar. 29, 2018

(30) Foreign Application Priority Data
Sep. 30, 2015 (FR) 1559271

(51) Int. Cl. C08G 18/02; C09D 175/04; C09D 175/02; C09J 175/04; C09J 175/02

(52) U.S. Cl. CPC C08G 18/027; C09D 175/04; C09J 175/02; C09J 175/04; C09D 175/02

(57) ABSTRACT

In the field of polyisocyanate compositions for the production of coatings and adhesives, the disclosed composition combines a polyisocyanate compound with biuret motifs, a protic, polar reactive diluent compound, one of the addition compounds thereof, and an aprotic reactive diluent compound. Also disclosed is a method for producing the composition, and to the use thereof for producing a coating or an adhesive.

The invention concerns the field of polyisocyanate compositions for the production of coverings and adhesives. The composition covered by the invention combines a polyisocyanate compound with biuret motifs, a polar and proteic reagent diluent compound, one of their additional compounds and an apolar and aproteic reactive diluent compound. The polyisocyanate compositions covered by the invention can be used with high levels of dry extract. The invention also concerns a procedure for preparing the composition covered by the invention as well as its use for production of a covering or adhesive.

Generally speaking, in the field of polyisocyanate compounds for the production of coverings and adhesives, the properties sought in relation to known compositions are reduced viscosity and increased functionality. Stability of composition and compatibility with other chemical substances used during the production of coverings and adhesives are also sought.

Prior arts refer to numerous polyisocyanate compositions for preparation of coverings or preparation of adhesives. However, these compositions present shortcomings linked to their viscosity, which is often too high. Excessive viscosity in polyisocyanate compositions in the state of the art can prevent them being used as a hardener in polyurethane or polyurea applications. Excessive viscosity can also prevent them from being used in applications with high dry extract percentages or in applications with 100% dry extract.

To reduce the viscosity of compositions in the state of the art, solvents are regularly used. The use of solvents leads to problems with costs as well as environmental or toxicity-related problems.

The compositions in the state of the art sometimes have insufficient levels of functionality, especially for low-viscosity compounds. The state-of-the-art polyisocyanate compounds also present problems when they are applied. One problem encountered concerns the long time taken for foam to disappear when these compositions are used.

The compatibility of state-of-the-art polyisocyanate compositions, especially with polar polyols, for example with polyesters, is also problematic.

The drying time for coverings compositions prepared using state-of-the-art polyisocyanate compositions is frequently too long and therefore problematic.

The preparation procedures for the state-of-the-art compositions also pose problems, especially those linked to use of different catalysts during successive synthesis processes.

It is therefore important to have access to preparation processes that are simple to apply and are more economical than the state-of-the-art techniques.

It is also important to have access to procedures that provide increased output.

There is thus a need to have access to polyisocyanate compositions for production of coverings or production of adhesives that provide solutions to the problems of the state-of-the-art compositions. Similar needs exist with regard to polyisocyanate composition preparation procedures for preparing coverings or adhesives.

The invention provides a composition that introduces a solution to some or all of the polyisocyanate composition problems in the preparation of coverings or of state-of-the-art adhesives.

The invention therefore concerns a composition with an average isocyanate functionality level of over 2.5, comprising:
at least one polyisocyanate compound with biuret motifs (a);
at least one polar and proteic reactive diluent compound, chosen from among the polyisocyanate compounds with allophanate motifs and viscosity, when measured at 25° C., of less than 500 mPa·s;
at least one additional compound (c) with a compound (a) and a compound (b) and
at least one aproteic reactive diluent compound (d).

Preferably, the compound (d) should be an aproteic apolar compound.

The polyisocyanate compound with biuret motifs (a) according to the invention therefore contains biuret functions. These biuret functions may most notably be present within biuret compounds produced from 3 monomers (n=3), bi-biuret compounds produced from 5 monomers (n=5), biuret compounds issued from more than 5 monomers (n>5) or dimer biuret compounds.

The term “proteic polar reactive diluent compound” (b) refers to a compound that contains at least one isocyanate function and preferably two, and a function characterised by the —N—H—C(═O)—N(—)—C(═O)— chain capable of establishing a hydrogen link between the hydrogen carried by the nitrogen and the oxygen from the non-vicinal carbonyl group —(C═O)— of the nitrogen atom carrying the hydrogen atom.

The additional compound (c), according to the invention, comprises at least one biuret function and at least one function characteristics of the proteic polar reactive diluent (b) and at least 4 monomer units obtained from the initial isocyanate compound(s), preferably diisocyanate compounds. The compound (c) therefore combines at least one biuret function and at least one of the functions chosen from amongst the allophanate functions. The NCO function of the additional compound (c) is at least 2, and preferably should be higher than 2.

The additional compound (c) according to the invention therefore contains biuret functions and at least allophanate functions.

The viscosity of the composition according to the invention can vary quite widely. Beneficially, the viscosity measured at 25° C. of the composition according to the invention is less than 30,000 mPa·s, preferably less than 10,000 mPa·s., preferably less than 5,000 mPa·s, preferably less than 2,000 mPa·s, beneficially lower than 1,500 mPa·s, beneficially lower than 1,200 mPa·s, and even more preferably 1,000 mPa·s.

Just as preferably, the composition according to the invention has an average isocyanate functionality of over 2.75. More preferably, this average isocyanate functionality is over 2.8 and preferably should exceed 3.

The composition according to the invention contains isocyanate functions (NCO) obtained from the different compounds present and therefore has an NCO titre that can vary widely.

The NCO titre is beneficially between 10% and 25% by weight, and preferably between 15% and 24% by weight.

According to the invention, the compound (b) has an NCO functionality equal to 2+/−0.5, preferably equal to 2+/−0.3, and more preferably equal to 2+/−0.2. According to the invention, the average NCO functionality of the compound (b) may be chosen from an NCO functionality between 1.9 and 2.5; an NCO functionality between 1.9 and 2.3; an NCO functionality between 1.9 and 2.2; an NCO functionality between 1.9 and 2.1; an NCO functionality between 2 and 2.5; an NCO functionality between 2 and 2.3; and an NCO functionality between 2 and 2.2.

The quantities of compounds (a), (b), (c) and (d) may vary. Preferably, the composition according to the invention should contain 40-90% by weight, preferably 40-80% by weight, preferably 40-70% by weight, beneficially 40-60% by weight and even more beneficially 40-50% by weight, of compound (a).

Preferably, the composition according to the invention should contain 2-50% by weight, and preferably 5-50% by weight, of compound (b).

Preferably, the composition according to the invention should contain 40-90% by weight, preferably 40-80% by weight, preferably 40-70% by weight, beneficially 40-60% by weight, and even more beneficially 40-50% by weight of compound (a) and 2-50% by weight, preferably 5-50% by weight, of compound (b).

Preferably, the composition according to the invention should contain 0.5-40% by weight, preferably 0.5-20% by weight, and preferably 0.5-10% by weight, of compound (c). Preferably, the composition according to the invention should contain 1-20% by weight of compound (d).

Beneficially, the composition according to the invention should contain:
40-90% by weight, preferably 40-80% by weight, preferably 40-70% by weight, beneficially 40-60% by weight, and even more beneficially 40-50% by weight, of compound (a); and/or
2-50% by weight or 5-50% by weight of compound (b); and/or
0.5-40% by weight, preferably 0.5-20% by weight or 0.5-10% by weight of compound (c) and/or
1-20% by weight of compound (d).

Compound (a) in the composition according to the invention is beneficially prepared using an isocyanate monomer compound chosen from between 2-methyl-pentane diisocyanate (MPDI), hexamethylene diisocyanate (HDI), tetramethylene diisocyanate, pentamethylene diisocyanate, octamethylene diisocyanate, butylene diisocyanate, octylene diisocyanate, trimethylhexane diisocyanate, dodecane diisocyanate, undecane diisocyanate, 2,2,4-tri-methyl-hexamethylene diisocyanate, 2,4,4-tri-methyl-hexamethylene diisocyanate, 1,8-diisocyanato-4-isocyanato-methyl octane, 1-decane-triisocyanate, isophorone-diisocyanate (IPDI), xylylenediphenyl diisocyanate (XDI), meta-xylylenediphenyl diisocyanate (MXDI), para-xylylenediphenyl diisocyanate (PXDI), methylene-dicyclohexyl-4-4′-diisocyanate (H₁₂MDI), hexahydrogeno-tolyl-diisocyanate (H₆TDI), lysine diisocyanate derivatives, BICs and NBDI. Preferably, the monomer used to prepare the polyisocyanate compound with biuret motifs (a) in the composition according to the invention is chosen from amongst linear aliphatic diisocyanate monomer compounds such as 2-methyl-pentane diisocyanate (MPDI), hexamethylene diisocyanate (HDI), tetramethylene diisocyanate, pentamethylene diisocyanate, octamethylene diisocyanate, butylene diisocyanate, octylene diisocyanate, trimethylhexane diisocyanate, dodecane diisocyanate, undecane diisocyanate, 2,2,4-tri-methyl-hexamethylene diisocyanate, 2,4,4-tri-methyl-hexamethylene diisocyanate, 1,8-diisocyanato-4-isocyanato-methyl-octane, 1-decane triisocyanate. The preferred isocyanate monomer is hexamethylene diisocyanate (HDI).

Compound (b) in the composition according to the invention is beneficially prepared using an isocyanate monomer compound chosen from among 2-methyl-pentane diisocyanate (MPDI), hexamethylene diisocyanate (HDI), tetramethylene diisocyanate, pentamethylene diisocyanate, octamethylene diisocyanate, butylene diisocyanate, octylene diisocyanate, trimethylhexane diisocyanate, dodecane diisocyanate, undecane diisocyanate, 2,2,4-tri-methyl-hexamethylene diisocyanate, 2,4,4-tri-methyl-hexamethylene diisocyanate, 1,8-diisocyanato-4-isocyanato-methyl octane, 1-decane triisocyanate, isophorone diisocyanate (IPDI), xylylenediphenyl diisocyanate (XDI), meta-xylylenediphenyl diisocyanate (MXDI), para-xylylenediphenyl diisocyanate (PXDI), methylene-dicyclohexyl-4-4′ diisocyanate (H₁₂MDI), hexahydrogeno-tolyl diisocyanate (H₆TDI), lysine diisocyanate derivatives, BICs and NBDI. Preferably, the monomer used to prepare the polyisocyanate compound with biuret motifs (a) in the composition according to the invention is chosen from amongst linear aliphatic diisocyanate monomer compounds such as 2-methyl-pentane diisocyanate (MPDI), hexamethylene diisocyanate (HDI), tetramethylene diisocyanate, pentamethylene diisocyanate, octamethylene diisocyanate, butylene diisocyanate, octylene diisocyanate, trimethylhexane diisocyanate, dodecane diisocyanate, undecane diisocyanate, 2,2,4-tri-methyl-hexamethylene diisocyanate, 2,4,4-tri-methyl-hexamethylene diisocyanate, 1,8-diisocyanato-4-isocyanato-methyl-octane, 1-decane triisocyanate. The preferred isocyanate monomer is hexamethylene diisocyanate (HDI).

Preferably, compound (b) used according to the invention should mostly be produced from a monoalcohol, especially a monoalcohol in C₁-C₂₀, and an isocyanate monomer.

More preferably, compound (b) used according to the invention should be mostly from a mixture of a monoalcohol and polyols or of a monoalcohol and diols.

Beneficially according to the invention, compounds (a) and (b) may be prepared using the same isocyanate monomer compound.

To determine the viscosity of compound (b), it is possible to carry out synthesis in isolation, with a catalyst present if required. The various synthesis processes possible are known to specialists.

Preferably, compound (b) is a compound with the formula (I)

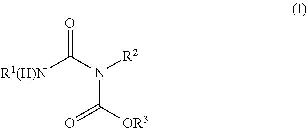

within which
R¹ and R², identical or different, independently represent a C₂-C₂₀ alkyl group, linear, cyclic or branched, containing at least one isocyanate function; preferably a C₂-C₁₂ alkyl group, linear, cyclic or branched, containing at least one isocyanate function; more preferably a C₂-C₁₂ alkyl group, linear or branched, containing at least one isocyanate function; especially a C₄-C₁₂ alkyl group, linear or branched, containing at least one isocyanate function;
R³ independently represents a heterocycloalkyl group C₅-C₁₀; an aromatic C₅-C₁₀ group; a C₅-C₁₀ alkyl-aryl group; a C₁-C₂₀ alkyl group, linear, cyclic or branched; preferably a C₁-C₁₂ alkyl group, linear, cyclic or branched; more preferably a C₁-C₁₂ alkyl group, linear or branched; especially a C₁-C₁₂ alkyl group, linear or branched; and in particular a C₃-C₈ alkyl group, linear or ramified.

Without the R¹ and R² groups of the formula (I) compounds, the isocyanate cyanate function may be a terminal function and as such located at the end of the alkyl chain, or may be a branch of the said alkyl chain. Preferably, the alkyl groups should not contain any tertiary carbon atoms.

For the formula (I) compounds, it is preferable to have compounds for which R¹ and R², identical or different, independently represent a C₂-C₈ alkyl group, linear or branched, containing an isocyanate function; preferably a hexyl group containing an isocyanate function.

For the formula (I) compounds, it is preferable to have compounds for which R³ independently represents a C₃-C₈ alkyl group, linear or branched; preferably a group chosen from amongst propyl, butyl, hexyl, octyl and 2-ethyl-hexyl. The different isomers of these groups are also suitable.

For the formula (I) compounds, R³ may also represent a C₅-C₁₀ heterocycloalkyl group containing at least one heteroatom chosen from amongst O, S and N.

The NCO function of the formula (I) compounds, according to the invention, may vary around the value of 2, especially according to the specific conditions for preparing these compounds.

Beneficially, according to the invention, the polyisocyanate compound with biuret motifs (a) and at least one polar and proteic reactive diluent component (b) may be prepared using the same isocyanate monomer compound.

The composition according to the invention may also include other compounds. In particular, it may contain other compounds with allophanate motifs, such as allophanates of polyols or of diols.

The composition according to the invention contains at least one compound (d). Preferably, the compound (d) shall carry at least one isocyanate function. More preferably, the compound (d) shall carry at least two isocyanate functions. The compound (d) shall not contain any hydrogen-bearing nitrogen capable of producing a hydrogen bond.

The compound (d) according to the invention shall beneficially have viscosity of less than 500 mPa·s measured at 25° C., and preferably viscosity measured at 25 CC between 20 and 500 mPa·s. More preferably, the compound (d) according to the invention shall have viscosity of less than 250 mPa·s, and preferably less than 150 mPa·s, measured at 25° C.

The compound (d) according to the invention shall be beneficially chosen from among a compound of formula (IV), a compound of formula (V), a compound of formula (VI) and a compound of formula (VII).

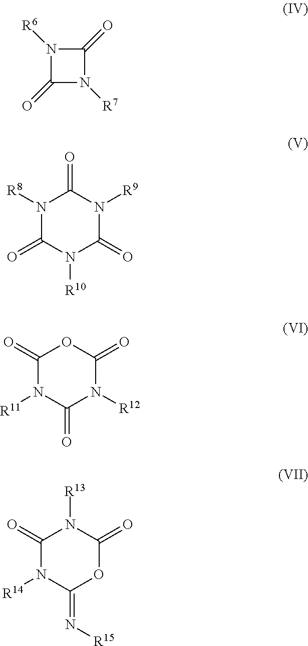

within which
R⁶ and R⁷, identical or different, independently represent a C₂-C₂₀ alkyl group, linear, cyclic or branched, containing at least one isocyanate function; preferably a C₂-C₁₂ alkyl group, linear, cyclic or branched, containing at least one isocyanate function; more preferably a C₂-C₁₂ alkyl group, linear or branched, containing at least one isocyanate function; especially a C₄-C₁₂ alkyl group, linear or branched, containing at least one isocyanate function;
R⁸, R⁹, R¹¹, R¹², R¹³ R¹⁴ and R¹⁵, identical or different, independently represent a C₂-C₂₀ alkyl group, linear, cyclic or branched; preferably a C₂-C₁₂ alkyl group, linear, cyclic or branched; more preferentially a C₂-C₁₂ alkyl group, linear or branched; in particular a C₄-C₁₂ alkyl group, linear or branched; a C₂-C₂₀ alkyl group, linear, cyclic or branched, containing at least one isocyanate function; preferably a C₂-C₁₂ alkyl group, linear, cyclic or branched, containing at least one isocyanate function; more preferably a C₂-C₁₂ alkyl group, linear or branched, containing at least one isocyanate function; in particular a C₄-C₁₂ alkyl group, linear or branched, containing at least one isocyanate function.

The polyisocyanate compounds in the composition according to the invention may be used as polyisocyanate hardeners with compounds containing mobile hydrogen atoms, such as polyols, polyamines and polythiols. The composition according to the invention may thus be used to produce coverings or adhesives containing one or more polyurethane, polyurea, polythiourethane or polyamide functions. The composition according to the invention may also be used for producing coverings that originate from reactions of isocyanate functions with compounds containing mobile hydrogen atoms through the creation of a urethane, allophanate, urea, biuret, isocyanurate, acylurea or amide bond.

The composition according to the invention may also be used as an initial polyisocyanate composition for transformation into crosslinkable compounds, most notably compounds that can be crosslinked by actinic radiation, especially by UV radiation. The composition according to the invention can thus be used to produce derivative compounds that contain a double bond capable of polymerisation with another double bond. Examples of these include acrylate urethane derivatives, methacrylate urethanes, itaconate urethanes, urea derivatives, amides, allophanates, acrylate acylureas and methacrylate acylureas. These derivatives may be crosslinked with other activated ether-ester double bond compounds that can be polymerised with the double-bond derivatives according to the invention. These products, for example, originate from the reaction of the compositions of the invention with hydroxyethyl acrylate derivatives, hydroxypropyl acrylate, hydroxyethyl methacrylate, hydroxypropyl methacrylate, acrylic acid, methacrylic acid, hydroxy alkyl acrylate compounds, hydroxy alkyl methacrylate compounds containing ether bonds originating for example from chains containing oligo ethylene glycol motifs, oligo propylene glycol motifs or oligo tetramethylene glycol motifs.

The composition according to the invention may also be used in the form of compounds with masked isocyanate functions. These compounds with masked isocyanate functions may be combined with compounds containing mobile hydrogen atoms, specifically present within OH, NH₂, —NH—, SH and C(O)OH functions. It is thus possible to produce so-called single-compound formulations that are stable at ambient temperature for several days, several weeks and even several months. By increasing the temperature, it is possible to form a film of covering because of thermic restoration of the isocyanate functions by release of the masking agents. The crosslinking temperature and the stability at ambient temperature of the 1K compounds obtained from the composition according to the invention may vary according to the masking agent used. The masking agents are generally known to specialists. In this way, masking agents of the imidazole type or substituted imidazole type on the nucleus by different alkyl groups, can be crosslinked at low temperatures in the region of 80° C. Masking agents of the caprolactam type will produce the highest levels of stability during storage, lasting several months at ambient temperature; effective crosslinking must thus be carried out at temperatures in excess of 150° C. Other masking agents can include oximes such as methyl ethyl cetoxime, cyclohexanoneoxime, derivatives of pyrazole or pyrazole alkyls such as dimethyl pyrazole, alkyl esters of malonic acid or betaceto esters, secondary amines such as diisopropylamine or tert-butyl benzylamine, phenol derivatives or esters of hydroxybenzoic or salicylic acid.

The composition according to the invention may also be used to prepare water-dispersible formulations by grafting a polyether compound, preferably mono alkyl ether. Preferably, this polyether compound contains only a reactive function with the isocyanate function. An amine salt, preferably a tertiary amine salt, or even a sulphonic aminoalkyl salt or a sulphamate salt, can be used. It is also possible simply to add compounds with phosphate ester dialkyl bases, phosphate ester monoalkyl bases, and sulphonate bases neutralised by amines, preferably by tertiary amines.

After transformation, these compounds can be used with water-dispersable polyols or polyurethanes dispersed in aqueous phase to produce paints or varnishes for aqueous phase. They may also be used to produce coverings or adhesives derived from the aqueous formulations.

The composition according to the invention may also be used to produce dispersions of masked polyisocyanates in aqueous phases or to prepare 1K formula dispersions.

The composition according to the invention can also be put into reaction with alkoxysilane compounds such as aminopropyl (di or tri) alkoxysilanes, aminomethyl (di or tri) alkoxysilanes, aminopropyl silazanes or aminomethyl silazanes, to produce systems that can be crosslinked through humidity, such as MS polymers. It can also produce systems which, through reaction with other alkoxysilane-type compounds, can improve certain mechanical properties such as resistance against scratching.

The composition according to the invention can be used in numerous applications involving the use of polyisocyanate compositions.

The invention, therefore, also concerns a composition used for polyurethane covering or a composition used for polyurea covering, which includes a composition according to the invention and at least one compound containing a hydrogen atom capable of reacting with an isocyanate group. The composition of the covering according to the invention therefore includes at least one composition according to the invention and at least one compound containing at least one group carrying a hydrogen atom capable of reacting with an isocyanate function, preferably chosen from amongst polyols and amines. Beneficially, the composition according to the invention allows increased covering formation speed compared with a state-of-the-art hardener composition.

The invention also concerns a composition for polyurethane adhesive or a composition for polyurea adhesive containing at least one composition according to the invention and at least one compound containing a hydrogen atom capable of reacting with an isocyanate group.

When the composition according to the invention is used, some or all of the NCO functions of the composition according to the invention can be protected. They may also be partially or totally blocked.

The invention also provides a water-dispersible composition containing a composition according to the invention and at least one ionic surfactant or at least one non-ionic surfactant. The invention also provides a water-dispersible composition containing a composition according to the invention whose NCO functions are totally or partially substituted using at least one ionic surfactant or using at least one non-ionic surfactant.

The composition according to the invention is also used beneficially in the preparation of polyurethane materials, polythiourethane materials, polyurea materials or polyamide materials. The composition according to the invention can thus be combined with compounds containing mobile hydrogen atoms to produce such materials, most notably mass materials and in particular materials for the preparation of items for which thickness is an essential property. The composition according to the invention is also beneficial when it is applied by reactive injection moulding (RIM).

The invention also concerns the use of a composition according to the invention within the fields of general organic chemistry, hardeners, mastics, adhesives, compounds that can be crosslinked by UV radiation, and heat-crosslinkable compounds, for compositions according to the invention within which the isocyanate functions are blocked. The invention preferably concerns the use of at least one composition according to the invention as a hardened for preparation of a covering or adhesive. Preferably, these uses concern the preparation of a polyurethane covering, a polyurea covering or a poly(urea-urethane) covering, or the preparation of a polyurethane adhesive, a polyurea adhesive, or a poly (urea-urethane) adhesive.

Another subject of the invention concerns a procedure for preparing a composition according to the invention. The invention therefore provides a procedure for preparing a composition, with an average isocyanate functionality level of over 2.5, and containing:
at least one polyisocyanate compound with biuret motifs (a);
at least one polar and proteic reactive diluent compound, chosen from among polyisocyanate components with allophanate motifs, with viscosity, measured at 25° C., of less than 500 mPa·s (b); and
at least one additional compound (c), one compound (a) and one compound (b). and
at least one aproteic reactive diluent compound (d), preferably apolar.

Particularly beneficially, the invention concerns a procedure for preparing the composition according to the invention, consisting of the following stages:
1) Preparation of at least one polyisocyanate compound with biuret motifs (a);
2) The preparation of at least polar and proteic reactive diluent compound, chosen from among polyisocyanate compounds with allophanate motifs, with viscosity, measured at 25° C., of less than 500 mPa·s (b);
3) Preparation of at least one additional compound (c); then
4) Separation of the excess isocyanate monomer.

Preferably, the procedure for preparing the composition according to the invention contains the following stages:
1) Preparation of at least one polyisocyanate compound with biuret motifs (a);
2) The preparation of at least one polar and proteic reactive diluent compound, chosen from among polyisocyanate compounds with allophanate motifs, with viscosity, measured at 25° C., of less than 500 mPa·s (b);
3) Preparation of at least one additional compound (c);
4) Preparation of at least one aproteic reactive diluent compound (d), preferably apolar; and then
5) Separation of the excess isocyanate monomer.

Depending on the nature of the compounds (a), (b) and (c), the preparation procedure may vary. Thus, beneficially, stages 1) and 2) according to the preparation procedure may be carried out first. Beneficially, stage 1), 2) or 4) according to the preparation procedure may be carried out first. Particularly beneficially, stages 1) and 2) or stages 2) and 3) according to the preparation procedure may be carried out simultaneously. Particularly beneficially, stages 1) and 2), stages 2) and 3), or stages 3) and 4), or stages 1), 2), 3) and 4), according to the preparation procedure, may be carried out simultaneously.

When the procedure according to the invention is applies, the monomers used to prepare compound (a) and the monomer used to prepare compound (b) are chosen independently. Preferably, compounds (a) and (b) are prepared using the same monomer, especially one chosen from among the linear aliphatic diisocyanate monomers and in particular hexamethylene diisocyanate (HDI).

Preferably, the procedure according to the invention is a procedure that involves one or more catalysts. Beneficially, the procedure according to the invention involves a biuretisation catalyst that helps catalyse stage 1) biuretisation and/or a allophanatation catalyst that helps catalyse stage 2) allophanation.

Beneficially, the procedure according to the invention can also involve only one catalyst, that is, a single catalyst, this catalyst being capable of catalysing the two stages 1) biuretisation and 2) allophanation.

The biuretisation catalyst used in stage 1) of the procedure of the invention (obtaining compound (a)) is preferably obtained from amongst the metallic carboxylates, especially metallic alkyl carboxylates. It is also possible to use dialkylphosphates and phosphate esters and diesters, especially those chosen from amongst butyl esters, 2-ethyl hexyl esters, decyl esters, dodecyl esters and neodecanoyle esters.

The allophanatation catalyst used in stage 2) of the procedure of the invention (obtaining compound (b)) should preferably be chosen from amongst carboxylates of bismuth, alkylcarboxylates of bismuth, carboyxlates of magnesium, alkylcarboxylates of magnesium, carboxylates of zinc, alkylcarboxylates of zinc, carboxylates of zirconium or alkylcarboxylates of zirconium.

According to a preferred procedure, it is possible to use a single catalyst to bring about the allophanatation reaction (stage 2 of preparation of compound (b)) and the buretisation reaction (stage 1 of preparation of compound (a)). In this preferred procedure, the single catalyst is chosen from amongst carboxylates of zinc and alkylcarboxylates of zinc.

Preferably, the molar ratio of the catalyst or the single catalyst is a radio determined as follows: total catalysts/number of OH functions (H₂O+Alcohols). This ratio is between 1.10⁻² and 1.10⁻⁵. When the catalyst contains only organometallic compounds, this molar ratio total catalysts/number of hydroxyl functions is equivalent to the molar ratio metal/total OH functions (H₂O+Alcohols).

Also preferably, the procedure according to the invention is a continuous process.

Beneficially, the compound (d) of formula (IV) and (V) may be prepared during a final stage of the procedure according to the invention, by heating the reaction milieu when the other reactions are completed.

Other compounds may be added to the composition according to the invention, such as at least one pyrophosphate or one of its derivatives, a diphosphate or one of its derivatives and salts and esters of pyrophosphoric acid.

The following examples provide an illustration of the various aspects of the invention.

The TOLONATE products used in the examples of applications are commercial polyisocyanates marketed by Vencorex. TOLONATE HDT has viscosity at 25° C. of 2,400+/−400 mPa and a NCO titre of 22+/−1% weight. TOLONATE HDT LV has viscosity at 25° C. of 1,200+/−300 mPa and a NCO titre of 23+/−1% weight. TOLONATE HDB LV has viscosity at 25° C. of 2,000+/−500 m Pas and a NCO titre of 23.5+/−1% weight.

The polyol ALBODUR U 955 is a polyol marketed by Alberding and Boley.

The polyols SETAL and SETALUX are polyols marketed by Nuplex Resins.

The organometallic catalysts are catalysts supplied by Aldrich, Acros, STREM, Alfa Aesar or TCI.

The di-alkyl phosphate ester compounds are products supplied by Acros.

Methyl amyl ketone (MAK) is supplied by Alfa Aesar.

Solvesso 100 is supplied by Exxon Mobil.

For all synthesis tests, the reaction milieu is filtered prior to distillation, in order to eliminate any insoluble substances that may have formed. The filter used is a Millipore PVDF Durapor filter (0.45 microns). The insoluble substance rate is determined by weighing the filter before and after filtration.

The analysis methods used are known to specialists in the field. The isocyanate oligomer analysis of the compositions was carried out using gel permeation chromatography combined with an infra-red analyser. To carry out the analysis, a known quantity of sample of polyisocyanate composition is injected into a set of two PL Gel columns in series. The oligomers are washed through with stabilised dichloromethane with amylene depending on their size, weight and molecular structure. The internal standard used is benzonitril at 100 microlitres for 10 mL of dichloromethane. The PL Gel columns used are PL Gel 50 A° 5 microns 60 cm long and 7.5 mm in diameter, and PL Gel 100 A° 5 microns 60 cm long and 7.5 mm in diameter. The pressure in the column is in the region of 81 bars. The flow is 1 mL/min. On leaving the columns, the compounds washed out are analysed using infra-red spectroscopy and quantified.

The compounds (a) contain the biuret polyisocyanate structures issued from 3 biuret noted monomer units (n=3) containing a single biuret function, the biuret polyisocyanate structures issued from 5 biuret noted monomer units (n=5) containing two biuret functions, the biuret polyisocyanate oligomers issued from more than 5 biuret monomer units (n>5) and the compounds whose structure contains at least one biuret function and at least one uretidine dione function.

The quantity of oligomers in the composition is shown as a weighted quantity except for the (c) compounds, for which a molar quantity of allophanate functions and the biuret functions contained in the compounds (c) are given. The calculation of the molar fraction of these functions is obtained by subtracting the molar quantities of the (b) compounds and the intermediary or intermediaries of the (b) compounds contained in the mass of final composition, from the molar quantity of the alcohol(s) introduced into the reaction milieu. The calculation is specified in the examples.

In the following examples, the catalyst(s) contain only one metal atom in their structure; therefore, the molar ratio total catalysts/number of hydroxyl functions is equivalent to the molar ratio metal/total OH functions (H₂O+Alcohols).

### EXAMPLE 1: PREPARATION OF LOW-VISCOSITY POLYISOCYANATE COMPOSITION USING A SINGLE CATALYST

In this test, zinc bi-2-ethyl hexanoate is used as a single catalyst for synthesis of the (b) compound and the (a) compounds.

In a double-envelope tricol reactor, equipped with mechanical stirring, a cooler and an addition bulb, 600 g (3.571 mol) of hexamethylene diisocyanate (HDI) is added in an inert atmosphere at ambient temperature. The temperature of the reaction milieu is raised to 110° C. 0.13 g of zinc bi-2 ethyl hexanoate, 80% by weight in white spirit is added to 4.26 g (57.6 mmol) of 1-butanol. This catalyst formulation is added to the reaction milieu. The temperature of the reaction milieu is raised to 130° C. and maintained for a further hour. The NCO titre of the reaction milieu is in the region of 1.15 mol for 100 g. It is observed by infra-red analysis that the reactive allophanate diluent of HDI and of n-butyl is formed. 6.6 g of liquid water is then added to the reactive medium in 1 hour. After the water is added, the temperature of the reaction milieu is raised to 150° C. After 2 hours of reaction at 150° C., the reaction is stopped by adding 0.670 g of acid dibutyl phosphate (3.18 mmol). The NCO titre of the reaction mass prior to distillation is 0.980 mol for 100 g of reaction milieu. 559.6 g of reaction mass is filtered to eliminate 0.37 g of solid impurities. The filtrate is then distilled in a vacuum at 140° C. to eliminate the excess HDI monomer. 169 g of polyisocyanate composition is obtained. The weighted output recovered is 30.2%.

The characteristics of the example 1 products obtained following distillation of the excess diisocyanate monomer used are shown in Table 1. The average NCO molar function is calculated on the basis of the composition analysed by gel permeation chromatography (GPC-IR).

TABLE 1

| NCO | Viscosity | | |
|---|---|---|---|
| titre % | mPas | Average molar | HDI transformation |
| weight | 25° C. | functionality, NCO | rate, % weight |
| 22.9 | 1066 | 3.01 | 32.5 |

The polyisocyanate composition is analysed by gel permeation chromatography combined with infra-red detection. It contains biuret-structured oligomers, a polar proteic reactive diluent of the allophanate type, at least one reaction compound containing an allophanate structure bonded covalently to a biuret structure and an aproteic reactive diluent of the uretidine dione type. The distribution of the compounds is shown in Table 2.

TABLE 2

| Type of | Compound of Example 1 | % |
|---|---|---|
| compound | composition | weight |
| | Monomer HDI | 0.25 |
| | HDI and butyl carbamate | 0.2 |
| (d) | HDI uretidine dione (HDI | 8 |
| | Dimer) | |
| (b) | HDI and n-butyl allophanate | 7.9 |
| (a) | Biuret-dimer, Biuret (n = 3, | 74.4 |
| | n = 5, n > 5) | |
| (c) | HDI and n-butyl biuret- | 8.95 |
| | allophanate polyisocyanate | |
| | derivatives | |

In the case of example 1, the molar fraction of allophanate functions of the (c) compounds is 0.024 for 169 g of composition.

It is calculated as follows:

Number of moles of alcohol compound (butanol) used−{Number of moles of (b) compounds (HDI and n-butyl allophanate) obtained in total mass of polyisocyanate composition in Example 1+number of moles of intermediate (b) compounds (butyl and HDI carbonate) obtained in total mass of polyisocyanate composition in Example 1}=0.0576−{((7.9 g/410)*169/100)+((0.2/242)*169/100)}=0.024

### EXAMPLE 2: PREPARATION OF LOW-VISCOSITY BIURET-BASE POLYISOCYANATE COMPOSITION WITH ANOTHER SINGLE CATALYST

Procedure is as for Example 1 but uses zinc bi-neodecanoate (bNZ) as reaction catalyst instead and in place of zinc bi-2-ethyl hexanoate. Zinc bi-neodecanoate presents a better toxicity profile. The quantities of reagents used are shown in Table 3.

TABLE 3

| Reagent | HDI | Water | 1-butanol | bNZ (dry extract) |
|---|---|---|---|---|
| Quantity in g | 600 | 6.6 | 4.26 | 0.15 |

The molar ratios are shown in Table 4.

TABLE 4

| NCO/OH | NCO/ | | |
|---|---|---|---|
| alcohol | water | bNZ/NCO | bNZ/OH alcohol |
| 124 | 19.5 | 52.10⁻⁶ | 0.0064 |

The quantity of polyisocyanate recovered following reaction and distillation of the diisocyanate monomer is 176 g, corresponding to a recovered weighted output of 31.5%. The quantity of insoluble substances present before distillation is 0.35 g against 562 g of reaction mass involved in distillation. The NCO titre of the reaction milieu before distillation is 0.985 mol for 100 g.

The characteristics of the products obtained after distillation of the excess diisocyanate used are shown in Table 5. The average NCO molar function is calculated on the basis of the composition analysed by gel permeation chromatography (GPC-IR).

TABLE 5

| NCO | Viscosity | | |
|---|---|---|---|
| titre % | mPas | Average molar | HDI transformation |
| weight | 25° C. | functionality, NCO | rate, % weight |
| 22.9 | 1070 | 2.99 | 33.4 |

The distribution of compounds in the final composition is shown in Table 6.

TABLE 6

| Type of | | |
|---|---|---|
| compound | Compound of Example 2 composition | % weight |
| | HDI monomer | 0.15 |
| | Carbamate of HDI and butyl and HAI | 0.2 |
| | and isopropyl | |
| (d) | HDI dione uretidine (HDI dimer) | 8 |
| (b) | Allophanate of HDI and of n-butyl | 7.9 |
| (a) | Dimer-biuret, Biuret (n = 3, n = 5, n > 5) | 76.1 |
| (c) | HDI and n-butyl biuret-allophanate | 7.65 |
| | polyisocyanate derivatives | |

In the case of example 2, the molar fraction of allophanate functions of the (c) compounds is 0.022 for 176 g of composition. The same type of calculation is carried out as for Example 1.

### EXAMPLE 3: PREPARATION OF LOW-VISCOSITY POLYISOCYANATE COMPOSITION WITH MODIFIED OPERATING CONDITIONS

Procedure is as for Example 2; the quantities of reagents are the same but the operating conditions are modified. The alcoholic formulation of the catalyst is added to the reaction milieu containing the HDI at ambient temperature. The temperature of the reaction milieu is raised from ambient temperature to 150° C. in 1 hour. The water is injected within 1 hour of the temperature reaching 130° C. The reaction milieu is maintained at 150° C. 2 hours after injection of the total quantity of water.

Under these conditions, the NCO titre of the reaction mass is 1.165 mol of NCO for 100 g before injection of the water commences. The NCO titre of the reaction milieu before distillation is 0.978 mol for 100 g. The HDI transformation rate is 32% weight. 454 g of reaction milieu is filtered via millipore and then purified by distillation of the HDI monomer. The quantity of insoluble substances obtained by filtering the reaction mass before distillation is 0.54 g. After distillation, 149 g of low-viscosity polyisocyanate with biuret motifs is recovered, making a recovered weighted output of 33%. The characteristics of the products obtained after distillation are shown in Table 7.

TABLE 7

| NCO titre % | Viscosity mPas | HDI transformation |
|---|---|---|
| weight | 25° C. | rate, % |
| 22.72 | 1,371 | 32 |

The distribution of compounds in the final composition is shown in Table 8.

TABLE 8

| Type of | | % |
|---|---|---|
| compound | Compound of Example 3 composition | weight |
| | Monomer HDI | 0.2 |
| | HDI urea | 0.1 |
| | HDI and n-butyl carbamate | 0.2 |
| (d) | HDI uretidine dione (HDI Dimer) | 7.1 |
| (b) | HDI and n-butyl allophanate | 9.7 |
| (a) | Dimer-biuret, Biuret (n = 3, n = 5, n > 5) | 73.9 |
| (c) | HDI and n-butyl biuret-allophanate | 9 |
| | polyisocyanate derivatives | |

In the case of example 3, the molar fraction of allophanate functions of the (c) compounds is 0.022 for 149 g of composition. The same type of calculation is carried out as for Example 1.

### EXAMPLE 4: PREPARATION OF LOW-VISCOSITY POLYISOCYANATE COMPOSITION WITH OTHER MODIFIED OPERATING CONDITIONS

Procedure is as for Example 3; the quantities of reagents are the same but the operating conditions are modified. The alcoholic formulation of the catalyst is added to the reaction milieu containing the HDI at ambient temperature. The temperature of the reaction milieu is raised from ambient temperature to 150° C. in 1 hour. The water is injected 1 hour after the temperature reaches 130° C., that is, once a 1-hour steady phase at 130° C. has passed. The reaction milieu is kept at 150° C. for 3 hours after all the water is injected. Under these conditions, the NCO titre of the reaction mass is 1.154 mol of NCO for 100 g before injection of the water commences. The NCO titre of the reaction milieu before distillation is 0.980 mol for 100 g. The HDI transformation rate is 32% weight. 567 g of reaction milieu is filtered via millipore and then purified by distillation of the HDI monomer. The quantity of insoluble substances obtained by filtering the reaction mass before distillation is 0.44 g. After distillation, 186 g of low-viscosity polyisocyanate with biuret motifs is recovered, making a recovered weighted output of 33%. The characteristics of the products obtained after distillation are shown in Table 9.

TABLE 9

| NCO titre % | Viscosity mPas | HDI transformation |
|---|---|---|
| weight | 25° C. | rate, % |
| 22.9 | 1,157 | 32 |

The distribution of compounds in the final composition is shown in Table 10.

TABLE 10

| Type of | | % |
|---|---|---|
| compound | Compound from composition in example 4 | weight |
| | Monomer HDI | 0.3 |
| | HDI urea | 0.1 |
| | HDI and n-butyl carbamate | 0.1 |
| (d) | HDI uretidine dione (HDI Dimer) | 8.5 |
| (b) | HDI and n-butyl allophanate | 10.3 |
| (a) | Dimer-biuret, Biuret (n = 3, n = 5, n > 5) | 70 |
| (c) | HDI and n-butyl biuret-allophanate | 10.7 |
| | polyisocyanate derivatives | |

In the case of example 4, the molar fraction of allophanate functions of the (c) compounds is 0.020 for 186 g of composition. The same type of calculation is carried out as for Example 1.

### EXAMPLE 5: PREPARATION OF LOW-VISCOSITY POLYISOCYANATE COMPOSITION WITH OTHER MODIFIED OPERATING CONDITIONS

Procedure is as for Example 3; the quantities of reagents are the same, but the operating conditions are modified. The alcoholic formulation of the catalyst is added to the reaction milieu containing the HDI at ambient temperature. The temperature of the reaction milieu is raised from ambient temperature to 150° C. in 1 hour. The water is injected within 1 hour of the temperature reaching 130° C. The reaction milieu is maintained at 150° C. 2 hours after injection of the total quantity of water.

Under these conditions, the NCO titre of the reaction mass is 1.167 mol of NCO for 100 g before injection of the water commences. The NCO titre of the reaction milieu before distillation is 0.968 mol for 100 g. The HDI transformation rate is 34% weight. 597 g of reaction milieu is filtered via millipore and then purified by distillation of the HDI monomer. The quantity of insoluble substances obtained by filtering the reaction mass before distillation is 0.37 g. After distillation, 189 g of low-viscosity polyisocyanate with biuret motifs is recovered, making a recovered weighted output of 33.5%. The characteristics of the products obtained after distillation are shown in Table 11.

TABLE 11

| NCO titre % | Viscosity mPas | HDI transformation |
|---|---|---|
| weight | 25° C. | rate, % |
| 22.6 | 1,366 | 34 |

The distribution of compounds in the final composition is shown in Table 12.

TABLE 12

| Type of | | % |
|---|---|---|
| compound | Compound of Example 5 composition | weight |
| | Monomer HDI | 0.5 |
| | HDI urea | 0.2 |
| | HDI and n-butyl carbamate | 0.2 |
| (d) | HDI uretidine dione (HDI Dimer) | 8.1 |
| (b) | HDI and n-butyl allophanate | 7.9 |
| (a) | Dimer-biuret, Biuret (n = 3, n = 5, n > 5) | 72.9 |
| (c) | HDI and n-butyl biuret-allophanate | 10.9 |
| | polyisocyanate derivatives | |

In the case of example 5, the molar fraction of allophanate functions of the (c) compounds is 0.0212 for 189 g of composition. The same type of calculation is carried out as for Example 1.

### EXAMPLE 6: PREPARATION OF LOW-VISCOSITY POLYISOCYANATE COMPOSITION WITH MORE THAN ONE (B) COMPOUND AND TWO CATALYSTS

Two proteic polar reactive diluents, allophanate type, are synthesised using two mono-alcohols. Two types of catalyst are used. To synthesise the allophanate reactive diluents, a metallic salt of carboxylic acid is used, especially zinc bi-2-ethyl hexanoate (catalyst 1). To synthesise the biuret, an acid phosphate dialkyl is used (catalyst 2 or DBP). The quantities of reagents used are shown in Table 13

TABLE 13

| | Reagents | | | | | |
|---|---|---|---|---|---|---|
| | | | 1- | 2- | Catalyst | Catalyst |
| | HDI | Water | butanol | propanol | 1 | 2 |
| Quantity in g | 700 | 7.7 | 4.9 | 2.1 | 0.137 | 0.875 |

The molar ratios are shown in Table 14

TABLE 14

| NCO/OH | NCO/ | Catalyst 1/ | Catalyst 1/ | DBP/ | NCO/ |
|---|---|---|---|---|---|
| alcohols | water | NCO | OH alcohols | NCO | DBP |
| 83 | 19.5 | 47.10⁻⁶ | 0.0039 | 0.0005 | 1984 |

The NCO titre of the reaction milieu at the end of the reaction is 0.957 mol for 100 g. After filtration, the quantity of reaction milieu sent for distillation is 676 g. The insoluble substance ratio is negligible. The quantity of polyisocyanate composition recovered following distillation of the excess diisocyanate monomer is 239 g; this produces a weighted output of 35.4%. The characteristics of the products obtained after distillation are shown in Table 15.

TABLE 15

| NCO titre | Viscosity | Average molar | HDI transformation |
|---|---|---|---|
| % weight | mPas 25° C. | functionality, NCO | rate, % (GPC) |
| 22.6 | 1202 | 3 | 39 |

The distribution is shown in Table 16.

TABLE 16

| Type of | | |
|---|---|---|
| compound | Compound of Example 6 composition | % weight |
| | Monomer HDI | 0.21 |
| | HDI mono carbamates | 0.2 |
| (d) | HDI uretidine dione (HDI Dimer) | 7.7 |
| (b) | Allophanates of HDI & n-butyl and of | 12.7 |
| | HDI & isopropyl (n = 2) | |
| (a) | Dimer-biuret, Biuret (n = 3, n = 5, n > 5) | 72.2 |
| (c) | Biuret-allophanate polyisocyanate derivatives | 7.6 |
| | of HDI and of (n-butyl and isopropyl) | |

In the case of Example 6, the molar fraction of allophanate functions of the (c) compounds is 0.025 mole per 239 g of composition. The same type of calculation is carried out as for Example 1.

### EXAMPLE 7: PREPARATION OF LOW-VISCOSITY POLYISOCYANATE COMPOSITION WITH DIFFERENT CATALYST RATIO

The conditions of Example 6 are reproduced, but with a different Catalyst 1/NCO ratio. The quantities of reagents used are shown in Table 17.

TABLE 17

| | Reagent | | | | | |
|---|---|---|---|---|---|---|
| | | | 1- | 2- | Catalyst | Catalyst |
| | HDI | Water | butanol | propanol | 1 | 2 |
| Quantity in g | 500 | 5.5 | 3.5 | 1.5 | 0.052 | 0.625 |
| Quantity in | 2.976 | 0.306 | 0.047 | 0.0246 | 0.00015 | 0.003 |
| mol | | | | | | |

The molar ratios are shown in Table 18.

TABLE 18

| NCO/OH | NCO/ | Catalyst 1/ | Catalyst 1/ | DBP/ | NCO/ |
|---|---|---|---|---|---|
| alcohols | water | NCO | OH alcohols | NCO | DBP |
| 83 | 19.5 | 25.10⁻⁶ | 0.0021 | 0.0005 | 1984 |

The NCO titre of the reaction milieu at the end of the reaction is 0.967 mol for 100 g. After filtration, the quantity of reaction milieu sent for distillation is 468 g. The insoluble substance ratio is negligible. The quantity of polyisocyanate composition recovered following distillation of the excess diisocyanate monomer is 163 g; this produces a weighted output of 34.8%. The characteristics of the products obtained after distillation are shown in Table 19.

TABLE 19

| NCO titre | Viscosity mPas | Average molar | HDI transformation |
|---|---|---|---|
| % weight | 25° C. | functionality, NCO | rate, % (GPC) |
| 22.9 | 1328 | 3.15 | 36.6 |

The distribution of the compounds is shown in Table 20.

TABLE 20

| Type of | | |
|---|---|---|
| compound | Compound of Example 7 composition | % weight |
| | Monomer HDI | 0.13 |
| | HDI mono-carbamates | 0.1 |
| (d) | HDI uretidine dione (HDI Dimer) | 9.1 |
| (b) | Allophanates of HDI & n-butyl and of | 6.3 |
| | HDI & isopropyl | |
| (a) | Dimer-biuret, Biuret (n = 3, n = 5, n > 5) | 73.3 |
| (c) | Biuret-allophanate polyisocyanate derivatives | 11.07 |
| | of HDI and of (n-butyl and isopropyl) | |

In the case of Example 7, the molar fraction of allophanate functions of the (c) compounds is 0.046 mole per 163 g of composition. The same type of calculation is carried out as for Example 1.

The RMN ¹³C analysis with iron acetylacetonate present, performed using a Brucker AV 500 device, identifies and quantifies the constituent functions of the polyisocyanate composition. The molar distribution of the functions identified in the polyisocyanate composition is shown in Table 21.

TABLE 21

| Function identified, expressed in mol | |
|---|---|
| Isocyanurate function | 0.9 |
| Dimer functions (uretedine dione) | 5.2 |
| Allophanates function | 5.5 |
| Biuret functions | 19.8 |
| Sum total of functions identified | 31.4 |
| Molar ratio, biuret/biuret + allophanates function | 78.3 |
| Theoretical molar ratio, biuret/biuret + allophanates | 81.03 |
| functions based on number of moles of water and alcohols | |
| introduced | |

It is noted that the ratio (biuret functions/biuret+allophanates functions) measured by RMN ¹³C is very largely consistent with the theoretical ratio calculated on the basis of the initial compounds used in the procedure, as it reaches a level of 96.6%, thus demonstrating the efficiency of the procedure.

Notably, RMN ¹³C reveals the presence of a small quantity of isocyanurate type functions (2.84% of all functions identified) which were not identified by the gel permeation analysis coupled with infra-red. This means that during the synthesis procedure, a small quantity of HDI isocyanurate compound was formed.

RMN analysis of phosphorus 31 in a CDCl₃ milieu reveals an absence of catalyst acid phosphate dibutyl used during synthesis of the biuret, but reveals the presence of symmetrical and dissymmetrical pyrophosphate compounds, in a molar ratio respectively equal to 68/32. The presence of dissymmetrical pyrophosphates shows that during the reaction, partial hydrolysis of a butyl group of the acid phosphate dibutyl catalyst has occurred.

### EXAMPLE 8: APPLICATIONS OF POLYISOCYANATE COMPOSITIONS WITH 100% DRY EXTRACT

A formulation of a mixture of part A, containing compounds with reactive functions, with the isocyanate functions included in the polyisocyanate compounds of a part B, is prepared. The quantities are shown in Table 22.

For part A, a polyol resin is used (Product: ALBODUR U 955) with 8.79% of hydroxyl functions. For part B, the polyisocyanates from examples 3, 4 and 5 according to the invention are used, as are control polyisocyanates that are known (used and defined products). Tolonate HDT LV-NCO title: 22.78%, viscosity 1,185 mPa·s at 25° C., Tolonate HDB LV-NCO title: 23.37%, viscosity 2,062 mPa·s at 25° C. and Tolonate HDT-NCO title: 21.4%, viscosity 2,526 mPa·s at 25° C.). We are working with a NCO/OH function molar ratio of 1 and a quantity of 220 ppm of tin dibutyl-dilaurate (DBTL) as catalyst.

The products are weighed in a 250-ml beaker and then mixed using a propeller blade for 1 minute, at a speed of 300 rpm. The products are then degassed in a desiccator, under aspiration (10 bar) for about 5 minutes, until the foam disappears. The time taken for the foam to disappear is recorded. The results are shown in Table 22.

TABLE 22

| | | | | | |
|---|---|---|---|---|---|
| Part A-ALBODUR | 34 | 34 | 34 | 34 | 34 |
| Resin U955-g | | | | | |
| Part B-isocyanate | Example | Example | Example | HDTLV | HDT |
| hardener-g | 3 | 4 | 5 | product | product |
| | 32.54 | 32.26 | 32.69 | 32.43 | 34.52 |

| | | |
|---|---|---|
| Appearance after | Foam gone | Request foam |
| foam removal (5 | | removal time > 5 min |
| min) | | |

It is observed that the low-viscosity biuret motif polyisocyanates according to the invention show a shorter removal time and therefore have a faster application time than the known products. This is a significant advantage, because of the very low viscosity of the invention polyisocyanates.

For a first series of Shore hardness assessments, the formulation is poured into an aluminium capsule 74 mm in diameter. The quantity poured averages 30 g, to produce the required minimum thickness of 6 mm.

For a second series of traction assessments, the formulation is poured onto a polyethylene plaque measuring 8 cm×12 cm. The quantity poured averages 27 g, to produce the required minimum thickness of 2 mm. All of the preparations are stored in an air-conditioned room at 23° C. and 50% RH and then analysed after 7 days of storage. The results are shown in Tables 24 (Shore D hardness) and 25 (appearance after traction).

TABLE 24

| | Shore D hardness | | | |
|---|---|---|---|---|
| Part B | Day 1, t₀ | Day 1, t_{15 min} | Day 3 | Day 7 |
| Example 3 | 35/25 | 35/25 | 45/30 | 49/32 |
| Example 4 | 36/26 | 36/26 | 44/29 | 47/31 |
| HDTLV product | 27/18 | 27/18 | 36/25 | 42/28 |
| HDT product | 36/25 | 36/25 | 36/26 | 42/29 |

The mechanical property results obtained using a traction machine are shown in Table 25.

TABLE 25

| Polyisocyanate | Module (MPa) | Stress (MPa) | Distortion (%) |
|---|---|---|---|
| Example 3 | 6.34 | 8.72 | 157.58 |
| Example 4 | 6.04 | 7.42 | 142.61 |
| HDTLV product | 6.94 | 5.14 | 97.71 |
| HDT product | 7.56 | 5.76 | 105.32 |

It is observed that the very low-viscosity biuret motif polyisocyanates according to the invention present better performance levels compared to the Tolonate HDT LV and Tolonate HDT products. It is also observed that the low-viscosity biuret motif polyisocyanates according to the invention show better compatibility with |ALBODUR resin compared to the Tolonate HDT LV and Tolonate HDT products.

### EXAMPLE 9: APPLICATIONS OF POLYISOCYANATE COMPOSITIONS ACCORDING TO THE INVENTION AND OF FORMULATION REFERENCES WITH SOLVENT

Viscosity is measured using a Lamy “RHEOMAT” RM 300 rheometer. A sample of the product to be defined is placed in a tank. The stirring module is introduced and set going. The device shows the viscosity of the product at a given sheer level and a given temperature, for a period of one minute. The stirring module is chosen according to the target viscosity field. For the target compositions of the invention examples, the viscosity is given for a value at 25° C. and overall for a sheer gradient in the region of 100 s⁻¹.

The titre in NCO functions is measured using acid-base measurement. The measurement is carried out using a Metrohm 916 titrator. A sample of polyisocyanate composition with a known mass is set in reaction, with stirring, with dibutylamine solution of known titre and quantity, at ambient temperature (20° C. approx). The quantity of dibutylamine is excessive in relation to the isocyanate functions. After 1 minute, the reaction milieu containing the excess dibutylamine is measured at ambient temperature (20° C. approx) using a HCl solution with known titre. The difference between dibutylamine introduced initially and dibutylamine measured corresponds to the quantity of dibutylamine that has reacted with the isocyanate functions. We therefore have access to the isocyanate function titre of the polyisocyanate function, expressed either as a weighted % of NCO functions or as a mole of NCO functions for 100 g of polyisocyanate composition.

The Shore hardness measurement (D) is taken using a Hildebrand hardness meter.

The mechanical properties are measured using a MTS traction machine. The samples are prepared by pouring about 27 g of formula containing the target polyisocyanate onto a polyethylene plate measuring 12 cm by 8 cm to produce a thickness of 2 mm. The crosslinking is carried out in an air-conditioned room at 23° C. and 50% relative humidity (RH) and measured after 7 days of storage. Cutting is then performed using a removal device for the parts inserted into the traction machine, in order to measure the mechanical properties of the parts. The breaking elongation is then measured and expressed as a %, this being the elongation length beyond which the material breaks, the stress on rupture being expressed in N/mm² or MPa and being the force necessary to break a test sample measuring length×thickness. Generally speaking, the harder the material, the greater the stress on rupture.

The term “pot-life” defines the lifetime of a formula of 2 compounds (2K), which are a polyisocyanate hardener and a polyol or polyamine.

Persoz hardness allows paint layer hardness to be measured after cross-linking.

Impact resistance is measured using 2 Erichsen 304 marking devices according to Standards ISO 6272 dated 1993 and ASTM D 2794 dated 1984.

To measure folding resistance, an Erichsenconical chuck is used. The method allows the elasticity and adhesion forced of a paint film, subjected to bending, to be measured,

A formula is prepared, constituting a mixture of Part A containing compounds with reactive functions with the isocyanate functions contained in the polyisocyanates of a part B. The Part A used is a formulation of acrylic polyol in solvent and containing a mixture of two acrylic polyols (products: SETALUX 1907 BA 75 and Setal 1603 BA 78 X). Additives and a catalyst with tin dibutyl dilaurate base (DBTL) formulated to 1% weight are added to the n-butyl acetate (produced by Alfa Aesar). The products and quantities in Part A are shown in Table 26.

The two resins are weighed in a beaker and then stirred in a dispermat with a deflocculating blade, at a speed of 1500 rpm. During stirring, we add the products one by one, allowing 5 minutes for dispersion between each addition. When the additions are complete, Part A is left to be stirred for a further 20 minutes. We pour the formula into a closed glass flask and allow it to degas at atmospheric pressure for at least one night before using.

TABLE 26

| | % |
|---|---|
| | weight |
| Acrylic polyol (product: Setalux 1907 BA-75) | 70.06 |
| Polyester polyol (product: Setal 1603 BA-78) | 7.65 |
| Solvent 1 methyl amyl ketone (product: MAK) | 10.69 |
| Solvent 2 (product: Solvesso 100) | 4.37 |
| Additive 1 (product: Tinuvin 1130-BASF) | 1.36 |
| Additive 2 (product: Tinuvin 292-BASF) | 0.45 |
| Levelling agent (products: BYK-315, | 0.11, |
| BYK-332 (10% in AcBu), BYK-358) | 0.50, |
| | 0.30 |
| Catalyst (DBTL 1% in acbu) | 4.52 |

Part B consists of the polyisocyanate hardener. Invention polyisocyanates from examples 4 and 5 are used, together with reference polyisocyanate systems (products: Tolonate HDT, Tolonate HDB LV and Tolonate HDT LV from Vencorex).

Part C consists of a mixture of solvents for adjusting the viscosity (cutting) according to the proportions shown in Table 27. The two solvents are weighed in a glass flask and mixed for at least 30 minutes in the pot roller.

TABLE 27

| Solvent for cutting | % weight |
|---|---|
| Methyl amyl ketone | 47.87 |
| N-butyl acetate | 52.13 |

Next, the 2K varnish is prepared using a molar ratio of 1.1 for the NCO/OH functions. Parts A and B are weighed and then mixed manually using a spatula for 3-5 minutes, until a homogeneous mixture is obtained. The solvent part is added to the mixture, which is homogenised. The quantity of solvent to be added has been determined by DIN-4 cutting of about 24 seconds (readjustment of solvent according to DIN-4, 22-26 seconds). The products and proportions are shown in table 28.

TABLE 28

| Isocyanate | Example | Example | Tolonate | Tolonate | Tolonate |
|---|---|---|---|---|---|
| hardener | 4 | 5 | HDTLV | HDBLV | HDT |
| NCO titre (%) | 22.9 | 22.6 | 22.8 | 23.38 | 21.6 |
| Part A (% | 100 | 100 | 100 | 100 | 100 |
| weight) | | | | | |
| Part B (% by | 32.12 | 32.54 | 32.26 | 31.46 | 34.05 |
| weight) | | | | | |
| Part C (% by | 21.57 | 22.33 | 22.25 | 22.30 | 22.87 |
| weight) | | | | | |
| DIN 4 | 23.21 | 24.11 | 22 | 23.70 | 23.89 |
| (seconds) | | | | | |

The film is applied according to the tests to be carried out, using a manual applicator or a gun. The films are then dried at ambient temperature (23° C.) at 50% relative humidity (RH) or baked for 30 minutes at 60° C. following a 10-minute flash-off. All the films are stored in an air-conditioned room at 23° C. and 50% RH.

The hardness, brilliance and chemical resistance levels are assessed for films applied to a glass plate using a film-drawer 200 μm thick. Folding and QUV tests are carried out on films applied to an aluminium plate, the coverings consisting of an undercoat and base. The impact resistance and adherence tests have been performed on a steel plate, the coverings consisting of an undercoat and base.

TABLE 29

| Persoz hardness after drying | | | |
|---|---|---|---|
| at 70° C. | Time (days) | | |
| Isocyanate hardener | 1 | 3 | 8 |
| Example 4 | 150 | 249 | 274 |
| Example 5 | 155 | 258 | 280 |
| Tolonate HDTLV | 132 | 203 | 261 |
| Tolonate HDT | 132 | 241 | 273 |

The low-viscosity polyisocyanate hardeners according to the invention show a shorter network construction time than the reference polyisocyanates with an isocyanurate base (HDT and HDTLV) (Table 29).

The results shown in Table 30 are based on a number of ratings. The adherence rating ranges from 0 (excellent) to 5 (poor); the folding resistance rating ranges from 0 (excellent) to 5 (poor). The maximum AFNOR rating for impact resistance is 100. The maximum ASTM rating for impact resistance is 80. Impact resistance is better when the rating value is higher.

TABLE 30

| | Example | | Tolonate | |
|---|---|---|---|---|
| Isocyanate hardener | 4 | 5 | HDBLV | HDT |
| Adhesion | 3 | 4 | 5 | 5 |
| Folding resistance | Confirmed | Confirmed | Confirmed | Confirmed |
| ASTM impact resistance | 80 | 80 | 70 | 80 |
| AFNOR impact resistance | 100 | 100 | 90 | 100 |

The polyisocyanate hardener systems covered by the invention show a greater level of adherence and impact resistance than the HDT and HDBLV reference systems.

Overall, the hardeners according to the invention show a lower viscosity, with performances equivalent to and sometimes better than the reference isocyanate systems. A better adherence level and shock resistance level are noted.

### EXAMPLE 10: PREPARATION OF VERY LOW-VISCOSITY POLYISOCYANATE COMPOSITION

In this test, zinc bi-neodecanoate is used as a single catalyst in synthesis of the (b) allophanate reactive diluent and the (a) biuret-type compounds.

The procedure is as for Example 1, with different quantities of reagents used as shown in Table 31. The blocker used is dibutyl phosphate.

TABLE 31

| | | | | | Di-butyl |
|---|---|---|---|---|---|
| | | | | Zinc bi- | phosphate |
| Reagent | HDI | Water | 1-butanol | neodecanoate | acid |
| Quantity in g | 600 | 5 | 4.26 | 0.15 | 0.15 |

The molar ratios are shown in Table 32.

TABLE 32

| NCO/OH | NCO/ | | Metal/OH |
|---|---|---|---|
| alcohol | water | Metal/NCO | alcohol |
| 124 | 25.7 | 52 10⁻⁶ | 0.0064 |

The NCO titre of the reaction mass prior to distillation is 1.023 mol for 100 g of reaction milieu. 574 g of reaction mass is filtered to eliminate 0.2 g of solid impurities. The filtrate is then distilled in a vacuum at 140° C. to eliminate the excess HDI monomer. 150 g of polyisocyanate composition is obtained. The weighted output recovered is 26%. The characteristics of the example 10 products obtained following distillation of the excess diisocyanate monomer used are shown in Table 33. The average NCO molar function is calculated on the basis of the composition analysed by gel permeation chromatography (GPC-IR).

TABLE 33

| NCO | Viscosity | Average molar | HDI |
|---|---|---|---|
| titre % | mPas | functionality, | transformation |
| weight | 25° C. | NCO | rate, % weight |
| 23.2 | 686 | 2.8 | 26 |

The distribution of the compounds is shown in Table 34.

TABLE 34

| Type of | | % |
|---|---|---|
| compound | Compound of Example 10 composition | weight |
| | Monomer HDI | 0.28 |
| (d) | HDI uretidine dione (HDI Dimer) | 11.2 |
| (b) | HDI and n-butyl allophanate | 14.2 |
| (a) | Dimer-biuret, Biuret (n = 3, n = 5, | 69.3 |
| | n > 5) | |
| (c) | HDI and n-butyl biuret-allophanate | 5 |
| | polyisocyanate derivatives | |

In the case of example 10, the molar fraction of allophanate functions of the (c) compounds is 0.0056 for 150 g of composition.

### EXAMPLE 11: PREPARATION OF LOW-VISCOSITY POLYISOCYANATE COMPOSITION

In this test, zinc bi-neodecanoate is used as a single catalyst in synthesis of the (b) allophanate reactive diluent and the (a) biuret-type compounds.

The procedure is as for Example 1, with different quantities of reagents used as shown in Table 35.

TABLE 35

| | | | | | Dibutyl |
|---|---|---|---|---|---|
| | | | 1- | Zinc bi- | phosphate |
| Reagent | HDI | Water | butanol | neodecanoate | acid |
| Quantity in g | 600 | 7.5 | 4.69 | 0.15 | 0.15 |

The molar ratios are shown in Table 36.

TABLE 36

| NCO/OH | NCO/ | | Metal/OH |
|---|---|---|---|
| alcohol | water | Metal/NCO | alcohol |
| 113 | 17.2 | 52 10⁻⁶ | 0.0058 |

The NCO titre of the reaction mass prior to distillation is 0.893 mol for 100 g of reaction milieu. 562.5 g of reaction mass is filtered to eliminate 0.16 g of solid impurities. The filtrate is then distilled in a vacuum at 140° C. to eliminate the excess HDI monomer. 247 g of polyisocyanate composition is obtained. The weighted output recovered is 44%.

The characteristics of the example 11 products obtained following distillation of the excess diisocyanate monomer used are shown in Table 37. The average NCO molar function is calculated on the basis of the composition analysed by gel permeation chromatography (GPC-IR).

TABLE 37

| NCO | Viscosity | Average molar | HDI |
|---|---|---|---|
| titre % | mPas | functionality, | transformation |
| weight | 25° C. | NCO | rate, % weight |
| 21.6 | 3157 | 3.2 | 47 |

The distribution of the compounds is shown in Table 38.

TABLE 38

| Type of | | |
|---|---|---|
| compound | Compound of Example 11 composition | % weight |
| | Monomer HDI | 0.4 |
| (d) | HDI uretidine dione (HDI Dimer) | 4.5 |
| (b) | HDI and n-butyl allophanate | 9.4 |
| (a) | Dimer-biuret, Biuret (n = 3, n = 5, | 78.9 |
| | n > 5) | |
| (c) | HDI and n-butyl biuret-allophanate | 6.4 |
| | polyisocyanate derivatives | |

The (a) compounds represent about 79% weight of the composition of example 11. In the case of example 11, the molar fraction of allophanate functions of the (c) compounds is 0.0017 for 247 g of composition.

### EXAMPLE 12: VISCOSITY OF (B) COMPOUNDS

After synthesis of various (b) compounds, the characteristics of these compounds were then measured and are shown in Table 39. Viscosity was measured using the Rheomat 300 Module 114.

TABLE 39

| | Monomer | | Viscosity |
|---|---|---|---|
| Nature of | HDI content, | NCO titre | mPas at |
| alcohol | % weight | % weight | 25° C. |
| Butan-1-ol | 0.05 | 18.6 | 98 |
| Propan-2-ol | 0.1 | 20 | 124 |
| (IPA) | | | |
| Butan-2-ol | 0.5 | 19.4 | 124.7 |
| Cyclohexanol | 0.05 | 17.6 | 406 |

### EXAMPLE 13: PREPARATION OF AVERAGE-VISCOSITY POLYISOCYANATE COMPOSITION

The procedure is as for example 2, but with different quantities of reagents used, as shown in Table 40.

TABLE 40

| Reagent | HDI | Water | 1-butanol | bNZ |
|---|---|---|---|---|
| Quantity in g | 600 | 14 | 9 | 0.15 |

The molar ratios are shown in Table 41.

TABLE 41

| NCO/OH | NCO/ | | bNZ/OH | bNZ/OH |
|---|---|---|---|---|
| alcohol | water | bNZ/NCO | alcohol | totals |
| 59.5 | 9.2 | 52.10⁻⁶ | 0.0031 | 4.1 10⁻⁴ |

The quantity of blocking agent, di-butyl phosphate, corresponds to twice the molar quantity of catalyst.

The quantity of polyisocyanate recovered following reaction and distillation of the diisocyanate monomer is 249.5 g, corresponding to a recovered weighted output of 55.9%. The reaction mass involved in distillation is 466 g. The NCO titre of the reaction milieu before distillation is 0.778 mol for 100 g.

The characteristics of the products obtained after distillation of the excess diisocyanate used are shown in Table 42.

TABLE 42

| | | Average | HDI |
|---|---|---|---|
| NCO | Viscosity | molar | transformation |
| titre % | mPas | functionality, | rate, |
| weight | 25° C. | NCO | % weight |
| 19.7 | 21077 | > 4 | 63.9 |

### EXAMPLE 14: PREPARATION OF AVERAGE-VISCOSITY POLYISOCYANATE COMPOSITION

The procedure is as for example 2, but with different quantities of reagents used, as shown in Table 43.

TABLE 43

| Reagent | HDI | Water | 1-butanol | bNZ |
|---|---|---|---|---|
| Quantity in g | 600 | 10.7 | 5.9 | 0.15 |

The molar ratios are shown in Table 44.

TABLE 44

| NCO/OH | NCO/ | | bNZ/OH | bNZ/OH |
|---|---|---|---|---|
| alcohol | water | bNZ/NCO | alcohol | totals |
| 89.5 | 12 | 52.10⁻⁶ | 0.0046 | 5,5.10⁻⁴ |

The quantity of blocking agent, di-butyl phosphate, corresponds to three times the molar quantity of catalyst.

The quantity of polyisocyanate recovered following reaction and distillation of the diisocyanate monomer is 249.5 g, corresponding to a recovered weighted output of 55.9%. The reaction mass involved in distillation is 504 g. The NCO titre of the reaction milieu before distillation is 0.848 mol for 100 g.

The characteristics of the products obtained after distillation of excess diisocyanate monomer used are shown in the table. The average NCO molar function is calculated on the basis of the composition analysed by gel permeation chromatography (GPC-IR).

TABLE 45

| NCO | Viscosity | HDI |
|---|---|---|
| titre % | mPas | transformation |
| weight | 25° C. | rate, % weight |
| 19.7 | 21077 | 53 |

The distribution of the compounds is shown in Table 46.

TABLE 46
The molar

| Type of | | % |
|---|---|---|
| compound | Compound of Example 2 composition | weight |
| | Monomer HDI | 0.13 |
| (d) | HDI uretidine dione (HDI Dimer) | 3.7 |
| (b) | HDI and n-butyl allophanate | 5.1 |
| (a) + (c) | Dimer-biuret, Biuret (n = 3, n = 5, n > 5) | 91.07 |
| (c) | HDI and n-butyl biuret-allophanate | 20 |
| | polyisocyanate derivatives | |

fraction of the allophanate functions of the (c) compounds is 0.049 mole for 249.5 g of composition. The same type of calculation is carried out as for Example 1.

1. Composition with an average isocyanate functionality in excess of 2.5, comprising:
at least one polyisocyanate compound with biuret motifs (a);
at least one polar proteic reactive diluent compound (b), chosen from amongst the polyisocyanate compounds with allophanate motifs, with viscosity, measured at 25° C., of less than 500 mPa·s;
at least one additional compound (c) with a compound (a) and a compound (b) and
at least one aproteic reactive diluent compound (d).

2. Composition according to claim 1 comprising
40-50% by weight compound (a) or 40-60% by weight compound (a), or 40-70% by weight compound (a) or 40-80% by weight compound (a) or 40-90% by weight compound (a);
2-50% by weight or 5-50% by weight compound (b);
0.5-20% by weight or 0.5-10% by weight compound (c) and
1-20% by weight compound (d).

3. Composition according to claim 1, for which viscosity measured at 25° C. is less than 30,000 mPa·s.

4. Composition according to claim 1, with average isocyanate functionality in excess of 2.75.

5. Composition according to claim 1, independently containing at least one (a) compound and at least (b) compound prepared from an isocyanate monomer component chosen from amongst MPDI, HDI, tetramethylene diisocyanate, pentamethylene diisocyanate, octamethylene diisocyanate, butylene diisocyanate, octylene diisocyanate, trimethylhexane diisocyanate, dodecane diisocyanate, undecane diisocyanate, 2,2,4-tri-methyl-hexamethylene diisocyanate, 2,4,4-tri-methyl-hexamethylene diisocyanate, 1,8-diisocyanato-4-isocyanato-methyl octane, 1-decane triisocyanate, IPDI, XDI, MXDI, PXDI, H₁₂MDI, H₆TDI, diisocyanate lysine derivatives, BICs and NBDIs.

6. Composition according to claim 1, within which the (b) compound is a formula (I) compound 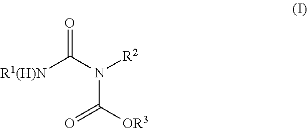
within which
R¹ and R², identical or different, independently represent a C₂-C₂₀ alkyl group, linear, cyclic or branched, containing at least one isocyanate function;
R³ independently represents a C₅-C₁₀ heterocycloalkyl group; a C₅-C₁₀ aromatic group; a C₅-C₁₀ alkyl-aryl group; a C₁-C₂₀ alkyl group, linear, cyclic or branched.

7. Composition according to claim 6, in which in which the (b) compound is a formula (I) compound within which
R¹ and R², identical or different, independently represent a C₂-C₈ alkyl group, linear or branched, containing an isocyanate function;
R³ independently represents a C₃-C₈ alkyl group, linear or branched.

8. Composition according to claim 1, in which the (d) compound is chosen from amongst a compound with formula (IV), a compound with formula (V), a compound with formula (VI) and a compound with formula (VII) 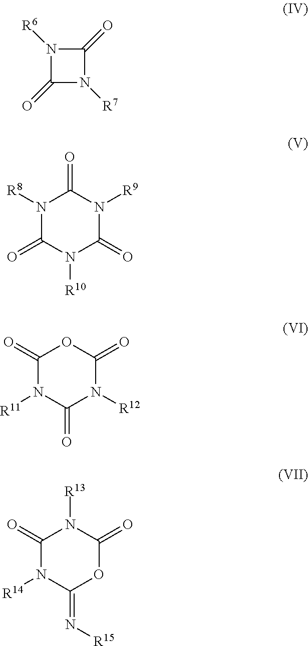
within which
R⁶ and R⁷, identical or different, independently represent a C₂-C₂₀ alkyl group, linear, cyclic or branched, containing at least one isocyanate function;
R⁸, R⁹, R¹¹, R¹², R¹³ R¹⁴ and R¹⁵, identical or different, independently represent a C₂-C₂₀ alkyl group, linear, cyclic or branched.

9. Procedure for preparing a composition according to claim 1, containing the following stages:
1) preparation of at least one polyisocyanate compound with biuret motifs (a);
2) preparation of at least one polar, proteic reactive diluent compound (b), chosen from amongst the polyisocyanate compounds with allophanate motifs, with viscosity, measured at 25° C., of less than 500 mPa·s;
3) preparation of at least one additional compound (c);
4) preparation of at least one polar and proteic reactive diluent compound (d); then
5) separation of excess isocyanate monomer.

10. Procedure according to claim 9 within which stage 1), 2) or 4) may be carried out first or within which stages 1) and 2), stages 2) and 3), stages 3) and 4), or stages 1), 2), 3) and 4) may be carried out simultaneously.

11. Procedure according to claim 9 within which stage 1) is carried out in the presence of a buretisation catalyst chosen from amongst metallic carboxylates, metallic alkyl carboxylates, dialkyl phosphates, phosphate esters and diesters, butyl esters, 2-ethyl hexyl esters, decyl esters, dodecyl esters and neodecanoyl esters.

12. Procedure according to claim 9, within which stage 2) is carried out in the presence of an allophanatation catalyst chosen from amongst carboxylates of bismuth, alkylcarboxylates of bismuth, carboxylates of magnesium, alkylcarboxylates of magnesium, carboxylates of zinc, alkylcarboxylates of zinc, carboxylates of zirconium and alkylcarboxylates of zirconium.

13. Procedure according to claim 9 within which stages 1) and 2) are carried out in the presence of a single catalyst chosen from amongst carboxylates of zinc and alkylcarboxylates of zinc.

14. Procedure according to claim 9 within which the total molar ratio of the catalyst(s)/number of OH functions is between 1.10⁻² and 1.10⁻⁵.

15. Method of preparation of a coating or adhesive comprising a step of preparing the composition according to claim 1.

16. Method according to claim 15 for the preparation of a polyurethane, polyurea or poly(urea-urethane) coating.

17. Method according to claim 15 for the preparation of a polyurethane, polyurea or poly(urea-urethane) adhesive.

18. Composition according to claim 1, for which viscosity measured at 25° C. is less than 10,000 mPa·s.

19. Composition according to claim 1, for which viscosity measured at 25° C. is lower than 5,000 mPa·s.

20. Composition according to claim 1, for which viscosity measured at 25° C. is lower than 2,000 mPa·s.
